(19) United States
(12) Patent Application Publication
(10) Pub. No.: US 2017/0330263 A1
(43) Pub. Date: Nov. 16, 2017

(54) LOCATION SPECIFIC MULTIMEDIA SYSTEM AND METHOD

(71) Applicant: FABTALE PRODUCTIONS PTY LTD, New South Wales (AU)

(72) Inventor: Frank J. SHAFFER, Queensland (AU)

(73) Assignee: FABTALE PRODUCTIONS PTY LTD, New South Wales (AU)

(21) Appl. No.: 15/518,713

(22) PCT Filed: Sep. 17, 2015
(86) PCT No.: PCT/AU2015/050559

§ 371 Date: Apr. 12, 2017

(30) Foreign Application Priority Data
Sep. 17, 2014 (AU) 2014903706

(51) Int. Cl. G06Q 30/06; G06Q 10/02; G06F 3/048; G06F 17/30; G06Q 50/00; G06Q 20/32

(52) U.S. Cl. CPC G06Q 30/0631; G06Q 50/01; G06Q 20/3274; G06F 3/048; G06F 17/30017; G06Q 10/02

(57) ABSTRACT

A method and system for permitting the capture of location specific content at a venue, such as a stadium or concert hall. Seat location data from patrons at the venue, for example provided by coding on the seats (egg a QR code), is used to identify the location and, upon demand, provide content to patrons, and to receive from patrons and store content associated with the seat.

### TECHNICAL FIELD

The present invention relates to the provision of online content relating to a specific geographical location.

### BACKGROUND OF THE INVENTION

Many forms of entertainment are provided in specific locations, such as concert halls and stadiums. These include cultural, sporting, musical and other performances and spectacles. The same venue will typically host a variety of event types. Some of the seating may be moveable or repositionable, and some may be only used for certain types of events. However, a large part of the seating is fixed and remains in the same position for many years.

Many sports stadiums have achieved an iconic stature as institutions in themselves, for example Wembley stadium, the Melbourne Cricket Ground, and Fenway Park. Over time, such stadiums come to have a long and rich history associated with them, so as to achieve a reputation and persona which is greater than the mere accumulation of events. This can also be the case for cultural venues such as the Sydney Opera House, Globe theatre and Radio City Music Hall.

In many cases, such venues promote their history and heritage, as do the sports authorities and other users of the venues. This in turn increases the value of the venue, and also the value of the particular sports or other organisation which becomes particularly associated with the venue. In some cases, for example iconic baseball and football teams, the home venue becomes an important part of the persona of the team. Consequently, enhancing the association between the venue and the patrons serves to increase the value of the team as well as the venue.

Existing schemes use stock footage and photos, and TV footage, to promote venues, games and events. This may be available online, and some historical information and statistics may also be available. However, there is considerable scope to improve and enhance the connection between patrons and the venue, so to provide an improved experience for the patrons.

It is an object of the present invention to provide a system and method for enhancing the association between patrons and supporters, and venues.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### SUMMARY OF THE INVENTION

In a first broad form, the present invention provides a facility to provide multimedia content, whether user derived or otherwise, and associate it with particular seats at a venue. This may involve the incorporation of a code onto the seat and/or ticket, to provide a linkage to an internet or network based facility, where a history of such multimedia content can be accessed, including by reference to the particular seat.

According to one aspect, the present invention provides a system for permitting the capture of location specific content at a venue, the system being adapted to receive data including seat location data from patrons at the venue, to identify the location and, upon demand, provide content to patrons, and receive from patrons and to store content selected with respect to at least the seat location data, the system including a server, data storage, and network communications apparatus so as to operatively enable the system to communicate with portable devices associated with patrons at the venue corresponding to the seat location data.

According to another aspect, the present invention provides a method for the capture of location specific content at a venue, the venue including seat location information which is readable by patrons, and wherein at least some of the patrons possess a portable device enabled and operatively adapted to interact with hardware, including a server, network communications hardware and data storage, and adapted to access the seat location information, the method including at least the steps of:

(a) the server receiving location data from one or more portable devices associated with patrons at the venue, the data being generated based upon seat location information read by the portable device; and

(b) said server then selectively, upon demand, providing content to patrons, receiving content from patrons, and storing content selected with respect to at least the seat location data, the system including a server, data storage, and network communications apparatus so as to operatively enable the system to communicate with portable devices associated with patrons at the venue corresponding to the seat location data.

### BRIEF DESCRIPTION OF THE DRAWINGS

Illustrative implementations of the present invention will now be described with reference to the accompanying figures, in which:

FIG. 1 is a screen shot of a home screen of a mobile phone/tablet app;

FIG. 2 is a screen shot of a video being shown on the same app;

FIG. 3 is a screen shot illustrating curated content such as ‘featured’;

FIG. 4 is a screen shot illustrating content uploading from an app;

FIG. 5 is screen shot illustrating an admin page which allows a venue operator to monitor and control what user uploaded content is viewable in curated streams available from a website;

FIG. 6 is a screen shot illustrating the creation and editing of content;

FIG. 7 is a view illustrating the application of a seat code according to the present invention to the seats in a stadium;

FIG. 8 is a view illustrating the application of a seat code according to the present invention to an entry ticket;

FIG. 9 is a flow chart for an illustrative hardware system for implementing the present invention; and

FIG. 10 provides an overview of the arrangement which is contemplated.

### DETAILED DESCRIPTION OF THE INVENTION

The present invention will be described with reference to the particular examples illustrated with respect to the accompanying figures. It will be appreciated that the figures and examples are intended to be illustrative of one implementation of the present invention, and not limitative of its scope.

Each item in society has in effect both a ‘virtual’ and ‘physical’ component which, when combined together, essentially determines its value as measured by a community or individual. For the purposes of this invention, it is understood that any virtual worth or value is merely a reflection of a society's estimation of often intangible aspects that can be especially difficult to quantify, document, collate, or measure. In addition, many of these virtual elements are often quite fragmented and disparate in their composition. This is in sharp contrast to the physical component which can be much more easily assessed based upon intrinsic elements, condition, or replacement costs.

It is further understood that these values of the physical elements tend to depreciate over time based on market forces and societal frameworks. However, the experience based component or virtual goods in the form of memories and use case histories have the possibility to accumulate and appreciate over time.

For example, an actual baseball used during a professional game has a small intrinsic value of perhaps $5. Over the course of a game it will typically be discarded, replaced, or given away as a souvenir within a few minutes or even seconds of its introduction. This leaves each ball very little time to accumulate any history, relevance, or virtual worth. However, what happens should the baseball be fortunate enough to intersect with a star player who hits a record breaking 715th homerun to become the game's all-time leader? Suddenly, all the history of the sports last 100 years has compressed itself into this moment in time and is transferred in part to this small baseball thereby hugely increasing its worth at auction. Other so called ‘physical witness’ objects related to the moment also now see a huge increase from their intrinsic value (ticket stubs, the bat, etc.). It is this transference of human experience, unique context, and history that underlies the ability of a physical item to actually ‘appreciate’ in value over time. Implementations of the present invention allow for a synergistic fusion of all these components in an engaging, efficient, and economical way which has not been done before. The history and nostalgic value of a specific seat, a team or a stadium's history can be virtually embedded with a specific location for future generations to interact with and see.

A problematic aspect of existing modes, such as television and the internet at large, is that they facilitate stay at home ‘couch browsing’ rather than live contextual experiences in the real world. Simply having viewed a YouTube video of the Grand Canyon does not in any sense provide a full substitute for the actual experience of being there. While on the one hand, the internet is often an excellent introduction to topics or events outside of one's home or office, it should not act as a substitute for real world experiences as such assumptions lead to shallow learning and understanding. The present invention seeks to address this sedentary internet shortcoming by enhancing live experiences in a personalised and contextual way on site by providing the best of both the physical and virtual worlds for patrons at live events. It facilitates the venue operator provide both the actual and virtual experiences for those attending an event.

The term venue will be used throughout the specification and claims to refer to any venue in which specific seats or positions are assigned and identifiable, for example sports stadiums, entertainment venues for concerts and the like, opera and ballet theatres, recital halls, drama and musical theatres, or even in principle smaller venues such as restaurants, bars, maternity wards, classrooms, nightclubs and the like. The term is intended to encompass any type of situation to which the present invention could be applied, including those not specifically mentioned herein.

The term venue operator is intended broadly and may encompass the actual real estate owner, the lessee, or the temporary operator such as the team or sporting code, or a visiting opera company or artist. Control and access can be negotiated and agreed as with any other commercial issue. It is envisaged that the arrangements for (e.g.) a major artist at a small venue may tend to favour control by the artist, whereas a completely different set of general rules would tend to be imposed by a major, iconic stadium.

The primary implementation of the present invention to be discussed has a front end which is an app for a smartphone or tablet, and a back end which is an internet based server, database and associated presentation, communications and searching software. Of course, it will be understood that the invention could be implemented using alternative means, for example as a web app, or as a standalone software product for home PCs and the like. However, the smartphone/tablet app implementation is preferred, as the image and video captured capabilities of such devices are a convenient way of capturing content for the purposes of the present invention, and this approach facilitates rapid and easy adoption by patrons.

It will be appreciated that the app is downloaded and/or made operative subject to terms and conditions of use, so as to govern issues of privacy, data collection, copyright in images and text, and other related issues.

The term ‘network’ is intended in its broadest sense. It includes public and private networks, illustratively those applying TCP/IP protocols such as the internet, but not limited to such networks. They may be local area networks (LANs), wide area networks (WANs). The physical implementation of such networks may be fixed, wireless, optical, satellite, mobile or any other suitable form. Mobile connections may be provided using any suitable technology, for example WiFi, cellular data, or any other suitable communications system. The present invention should not be construed as limited to particular communications or processing technology.

For the purposes of the present implementation, the venue is a baseball stadium. Each seat in a stadium (or at least a substantial number) has an associated code. This may be, for example, a QR code, as this readily allows for the code to be read and to take the user directly to a desired network location. However, other forms of coding could be used, for example a bar code, other optical or visual code, RFID device, or a magnetic code. Coding which can be read by an app on a conventional tablet or smartphone is preferred.

Alternatively, or in addition, the coding may be provided by a QR code or barcode on the entry ticket, season ticket, membership card or the like. For the purposes of this implementation, the coding needs to identify a particular seat, or conceivably group of seats if co-ticketed.

In one form, the coding could require both a code form the seat and a code from the ticket, in order to ensure that the patron is actually at the seat in question and entitled to be there and participate in the system.

The patron will have, either in advance or at the game, downloaded a suitable app from an application vendor, or installed it on their tablet smartphone or other device. For example, for an iPhone®, the app could be downloaded in a conventional way from the Apple® App Store, or using similar sites for an Android or Windows® based device. This may be a free app, one with a purchase price, or even a free app plus an option to upgrade to a more fully featured app upon payment of a fee.

In general overview, the present implementation allows for patrons to view and upload content, relevant both to the overall game, to their specific seat or area, and to receive content which is directed at their location and view. The platform for providing this content is illustratively controlled by the venue operator. Such a platform could be hosted by a team DJ, brand, or curator along with guest content created in the moment by fans or even celebrity attendees who wish to contribute their own perspective of the live event. Each seat in effect develops its own unique history thereby increasing its value to new and existing patrons. Over time a set of content relating to the specific seat can be developed, so that a patron can view messages and content created by, or relating to, the seat they happen to occupy for the game.

This platform also encourages audience engagement and participation. For example, a fly ball or home run could be captured from many different positions and angles by patrons, and all filed as ‘Billy Smith's Homer in the 8th Inning’ Fans and commentators can then have access to many more views and angles than is possible even with multiple camera arrangements. Particular patrons can have the pleasure of having their footage, attributed to them, shown by the video curator (VJ).

Such a platform could have multiple groupings split into a seat component along with a broader stadium element. Most of the content may only be viewable within the stadium while scanning a seat, or item's unique code to help emphasize the importance of time, context, and place in the physical world in which we live. This will also create further value to viewing a live event in person by providing a personalised historical context along with an increased communal experience. For example, upon check-in to a seat via their smart phone or tablet, audience members could:
create multimedia content for uploading to their seat and/or view prior history unique to that seat and its previous occupants along with branded content from the team or event management;
receive personalised messaging and or liner notes from a team, or a musical band at a concert. (e.g. happy birthday, history of a song while it's playing, locker room commentary, or a slide show);
receive promotions for branded specials, games, coupons etc. customised to each patron's seat and data; and/or
receive premium content which could be segregated based upon class of ticket, level of app downloaded, loyalty points or any other suitable way. This type of content may include POV camera from favourite players or managers, audio tracks etc. This allows for many layers of multimedia commentary by fans and broadcasters alike.

In addition to uploading content to one's seat, fans could also upload to a real-time communal stream of content from all the audience of a stadium that would flow across the platform much like a live stock ticker. This content could be from that day's event (or longer time period) or ephemeral and algorithmically rated/commented upon to determine which material becomes more prominent, featured, or spotlighted. Contests could be spun from the stream with the winning content displayed in the spotlight. Content could be additionally uploaded to other social media in which the patron participates.

The present invention may be conveniently implemented using a server based virtual facility, such as the facility operated by the applicant as FabZing. Details of the implementation of this system are provided in the applicant's patent application number WO 20112041827 (U.S. 61/272,545) and U.S. provisional application No. 61/746,774 by J Frank Shaffer. These disclosures are hereby incorporated by reference. A suitable implementation of a server based, user controlled multimedia messaging system is the FabZing system, which is available at www.fabzing.com and is commercially operated by Fabtale Productions Pty Ltd.

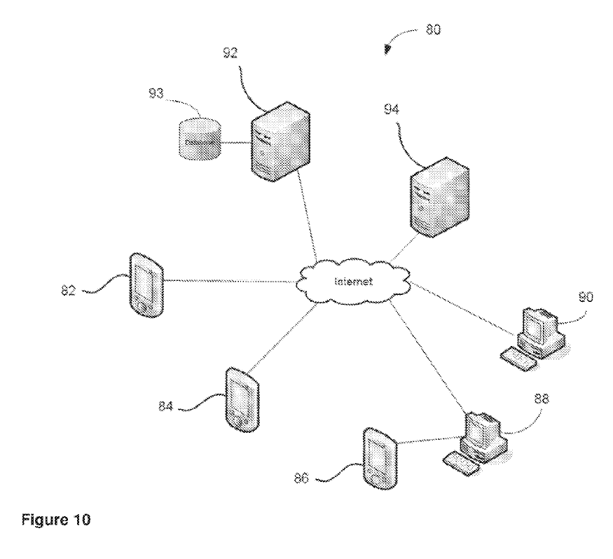

At FIG. 10, the server 92 provides the functional processing, including connection to stored information, account details, and the like required for the system to operate.

The network 80 includes one or more client processing systems and one or more server processing systems. In this example, the client processing systems include smartphone devices 82, 84, 86 and personal computers (PCs) 88, 90. The server processing systems include network servers 92 and 94. The client and server processing systems 82, 84, 88, 90 and 94 are connected via the internet 96 and the smartphone 86 is connected to the PC 88.

The transfer of information and/or data over the network can be achieved using wired communications means or wireless communications means. The server processing systems 92 and 94 can facilitate the transfer of data between the network and one or more databases, such as database 93.

It will be appreciated that embodiments of the invention may be realised over different networks, such as a MAN (metropolitan area network), WAN (wide area network) or LAN (local area network). Also, embodiments need not take place over a network, and the method steps could occur entirely on a client or server processing system.

It will be understood that the server used according to the present invention may be of conventional type. It may be a real server, or a virtual server distributed over several actual machines.

The user interface via the network can be using any device capable on the selected network, and which is able to read the code used according to the implementation of the invention. In the case of a visual code such as a QR code, this could be a conventional smartphone (e.g. iOS or Android based) with a camera, an app which can read and interpret a QR code, and internet access via a cellular network or wireless network such as WiFi. Any other suitable device may be used, for example a tablet computer, wearable computer, wearable system such as Google Glass®. Those skilled in the art will appreciate that such devices are widely available, and so the network and user hardware aspects will not be further described.

Functionally, the applicant's service (which may conveniently be based in the cloud) allows a user to create rich media content combining audio, text, graphics, images and video. The electronic documents created using the applicant's software, known as FabZings, incorporate multiple components to enable the provision of rich, personalised, user defined content.

It will be appreciated that the present invention is capable of being implemented using different systems, and is not limited in application or scope to the use of the applicant's Fab Zing system. Other web or network based approaches may be used, as will be understood by those skilled in the art. Similarly, different types of GUIs, interface sequences, screen commands and other features can be provided, notably using approaches to web design that are well known in the field.

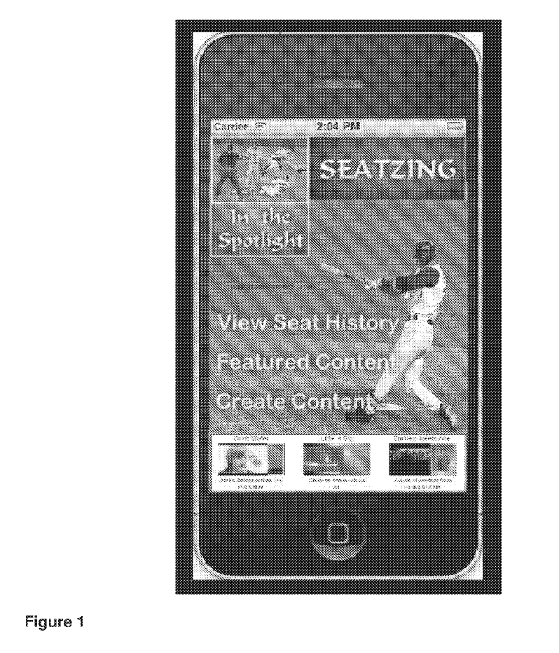

FIG. 1 illustrates a screen shot of the SEATZing app, which is used in this implementation of the present invention. The app provides options, which on the left side include Create Content, Featured Content and View Seat History. These will be explained in more detail below. On the top right, a video ‘screen in screen’ view shows the baseball ground on the day, for the initial state of the start screen. Below on the right is an indication of the seat location.

At the bottom strip of images representing video feed from other patrons at the ground, known as a ZingFeed. The images have a caption and an indication of the party who has pasted the, similar to a Twitter® feed in principle, so as to provide a communal feed as discussed above. Clicking or touching particular images causes the image to be played in a larger screen within screen.

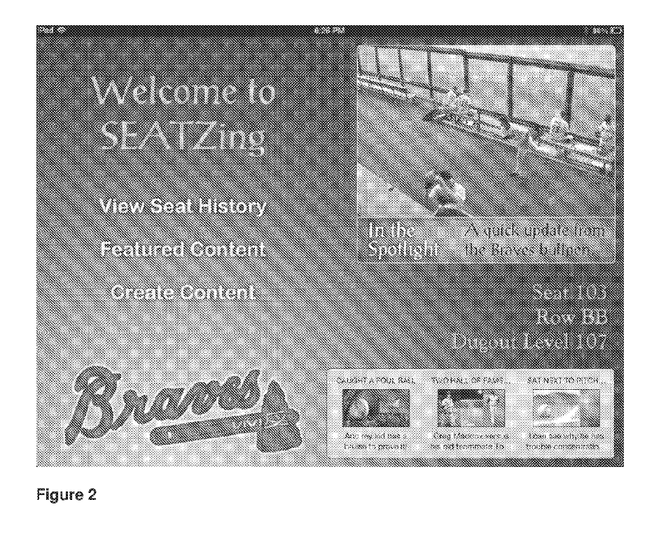

FIG. 2 shows the screen with a video feed and commentary of the bullpen in the top right screen. In this example, this has been triggered as part of the general feed controlled by the VJ. However, this could have been from a ZingFeed item, or as a result of selecting featured content.

View seat history enables the patron to see material relevant to the previous occupants of the seat. This may be by date, by using a feed strip similar to the ZingFeed, by an interface similar to YouTube®, or by any suitable mechanism. Certain popular or interesting messages, perhaps on the basis of rating by previous viewers, may be displayed first. The patron may be able to select the sort order, for example by date, most popular, only certain events (e.g. baseball only), notable events at the seat (for example, a home run ball being caught at that seat), or any other desired categories. It will be apparent that the appropriate categories will vary with the type of venue and event.

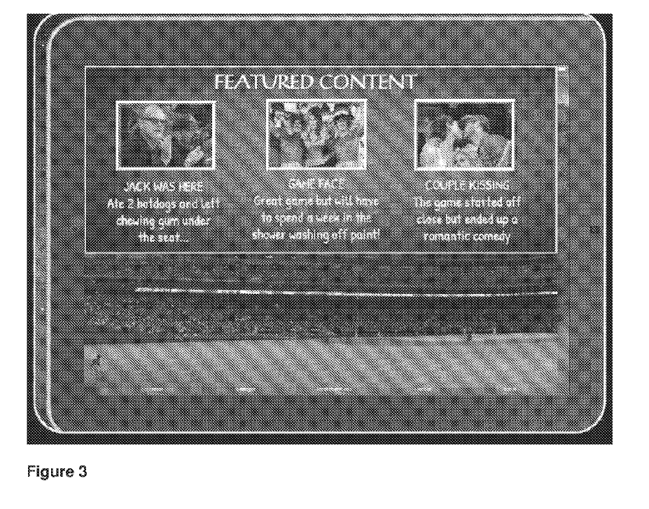

If the patron selects Featured Content, a screen such as FIG. 3 would be displayed. This is content selected by the VJ or operator. The selected images may, for example, be of celebrities, enthusiastic fans, humorous events or anything else deemed of interest, in addition of course to features which may include game highlights, and the like.

The app may also incorporate features such as a score screen, player histories and stats, the ability to select views and replays from the commercial feed, and the ability to select particular commentaries.

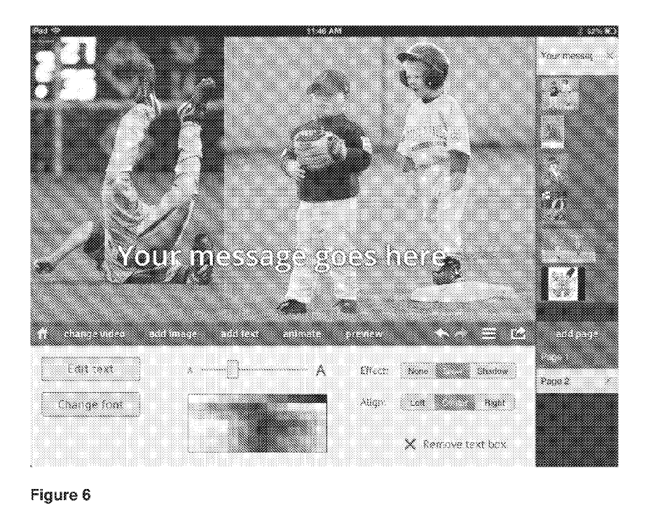

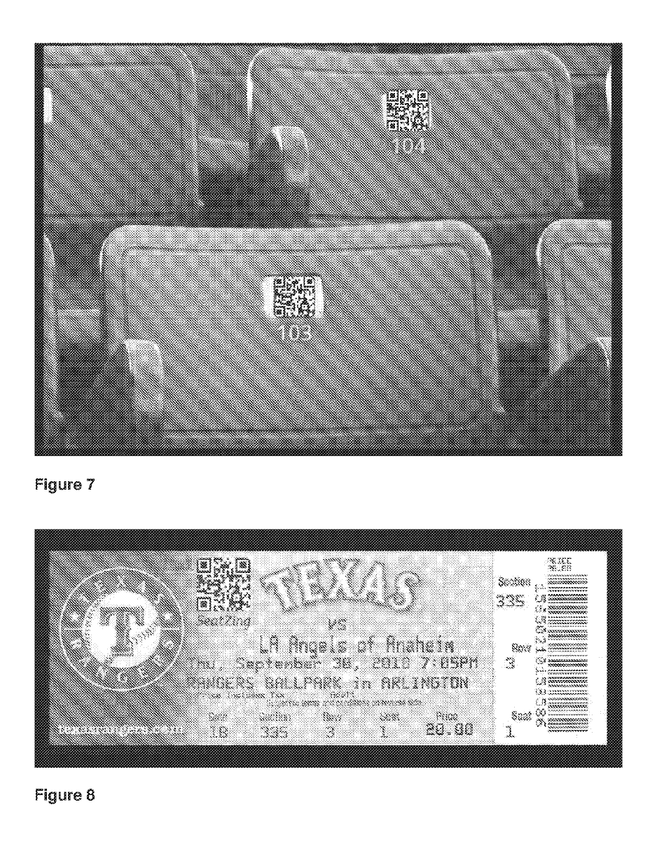

The patron may wish to add content themselves, which is done by clicking the Create Content button. FIG. 6 illustrates how this may then appear to a user. The user has already taken a photo or video, for this illustration. It will be appreciated that the app can readily prompt for such content to be taken or selected. Patron content can be seen, with a facility to add a comment, indicated by ‘add message here’. Conventional tabs allow for a different image or video to be selected, text to be added, and animations to be added. Conventional tools for adding effect, changing colour, alignment, font, etc. are also present.

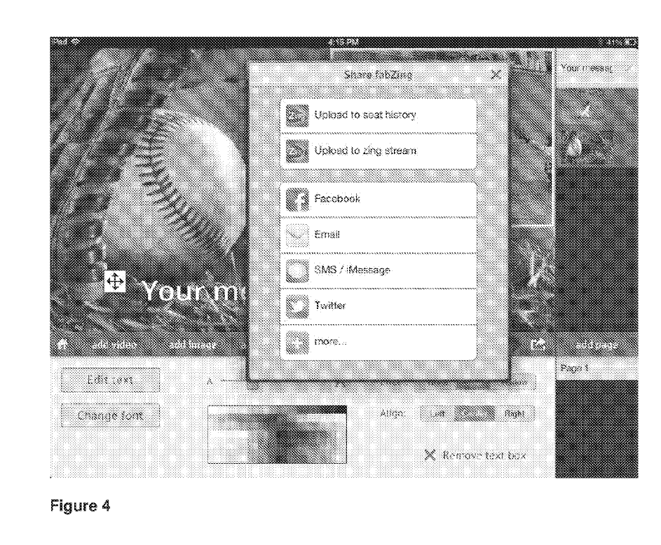

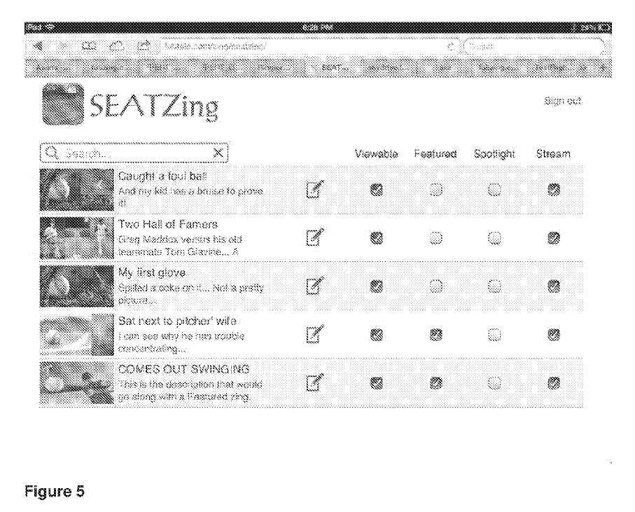

Once the content is created, FIG. 4 shows that a pop up box asks how the patron wishes to upload. Uploading to the seat history allows only those who later sit in the seat to have access, as well of course as administrators. Uploading to the zing stream allows for anyone with the app at the venue, and possibly those with web access, to view the content. It is also permission for the venue operator, VJ, etc. to select and use the content as part of their moderated display. It is presently preferred that there is an open approach to viewing a seat history, but it is preferred that contributing to that seat's history would be limited to ticketholders.

It can be seen that there are additional options to upload the content to selected social media sites. Thus, a patron may also show his friends and followers the content from the game which they have captured. This would also allow a team or venue to more closely assess and monitor the flow of media content rather than be subject to the fragmented and porous nature of the internet at large.

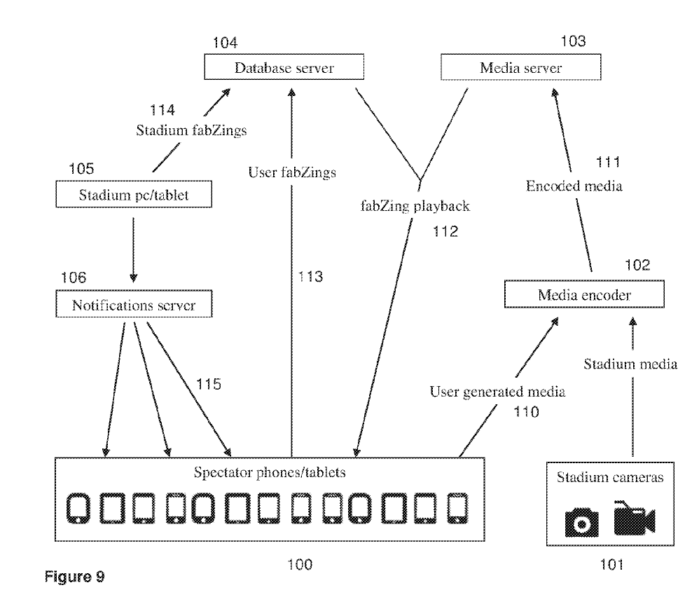

FIG. 9 illustrates schematically the flow of messages and data according to this implementation. The spectators have a large number of smart phones, tablets, or other devices 100 adapted to interact with the envisaged system. It will be appreciated that change and progress are to be expected in such devices, and the present invention is in no way limited to particular devices or types of devices.

The spectator devices 100, via their apps, are adapted to provide a variety of interactions to the user, as discussed above. User generated media (e.g. videos) are sent to the media encoder 102, which produces encoded media 111 for storage and distribution from the media server 103. The stadium cameras 101 similarly provide media to the media encoder 102.

User FabZings 113, generated using the apps on the spectator devices, are sent to the database server. It will be appreciated that that media and other components of the FabZing for playback 112 are provided by the media server 103 and the database server 104. FabZings may also be generated by the venue operator 105 via their tablet or PC, and sent as stadium FabZings 114 to the database server. The operator's pc or tablet may also send notifications to all or individual ones of the spectator devices 100.

The degree of external access, both to former ticketholders and to the public at larger, is a matter for control in the discretion of the venue operator. Allowing at least selected content to be available externally to the public would crystallize history and specific events, within the ongoing control of the venue operator. The operator would accumulate a depository of layered data consisting of memories, thoughts, comments, photos, moments, etc. which would forever be embedded into the stadium. For example, the invention could be implemented as a multi-tiered system, whereby premium content is available to those at the stadium and a seating chart to those online that would allow visitors to click on any seat in the diagram and pull up its history. Of course there would be the standard search measures e.g. by your favourite player's name, or year, a fan's name or ‘foul balls’ etc. Much of the history would be archived.

It will be appreciated that in the sporting context, additional features and options can be provided. For example, the audiences at an event could be segregated by a number of different factors such as team supported, seat location, clothing, or even beverage consumption. This could lead to a different feed being provided, different offer, and the like. It will be appreciated that the precise location of the patron is known, so that they can be altered that, for example, a concessionaire selling brand X beer will be in your section in 5 minutes, get your money out. The combination of precise location and willing participation by the patron creates many opportunities to provide a personalised experience, in an automated way.

The nature of the app and the information displayed will of course vary between sports. In the case of horse racing, for example, the app may include details of odds and betting markets, history of particular races and horses, and access to writer's analysis of the race. After each race, video of the race from various viewpoints and perspectives, conceivably including from the jockey's perspective, may be made available. In this context, some content may be available to all attendees, and additional seat based content only to those who have reserved seats. A wider range of material can be made available to the members, for example.

In the context of a sport like cricket, the availability of footage of past events at or near particular seats is as relevant as it is for baseball. In addition, game specific features are readily implemented, such as the details of runs and run rates required for a win, compared to a particular batsman and bowler's historical statistics, can be provided.

Another aspect which can be implemented is the provision of in stadium surveys and or sentiment measurements that can then be analysed and processed to determine various causal, direct, or indeterminate relationships between any number of factors. The app with a very specific seat based connection provides a convenient way to collect such data in a very specific context.

Another aspect which could be associated with the coded ticket or seat is secondary event or peripheral broadcasting so to speak. For some sports, associated parking lots and ‘the hill’ at Wimbledon could receive an auxiliary type of platform to enhance the ‘nearby’ atmosphere at sold-out events, etc. There could also be a time segmented platform, for example, a pregame show for those in the parking lot (e.g. at the Tailgate Party) which is available during the two hours before an event along with another show that is postgame full of analysis, interviews, and commentary, for consumption for example during the trip home.

The present invention may be advantageously combined with aspects of product based coding, as disclosed in co-pending application number AU 2013901094, the disclosure of which is hereby incorporated by reference.

One example of the application of the present invention is to fashion items, for example clothing, handbags, and shoes, or sporting goods such as shirts, gloves, balls, etc. A QR code may be incorporated into the item. In one form, the code may be a clear and obvious statement or part of a logo. It could be included only in a conspicuous way or in a non-obvious place. Alternatively, the QR code (or some other readable visual or transparent code) could be concealed within or incorporated into the pattern or design of the article.

The QR code is preferably unique to the article, and a permanent part of the article. It is preferred that the code remain part of the item, and not be (for example) merely on a swing tag or the like.

When the user reads the code, for example using a smartphone, it directs the reader to a FabZing server location. The FabZing server will be aware of the code, and can deal with the contact differently and dynamically. For example, on first contact, there may be a request to register the item as associated with the purchaser. In this case, if the item is stolen or not genuine, the server will not progress the session, and may for example alert authorities.

Such coding, for example on selected team merchandise, may be also provide an ability to create a personalised experience and relationship between a celebrity or player and a party who purchases a licensed item, which could be any suitable object such as a garment, game, sporting equipment, or other item. The item could include an integral code, which allows a connection to a dynamic website provided by a particular celebrity, team or other individual.

Once the purchaser (or gift recipient) receives the item, they are able to read the code, which takes them first to a registration page. This may require, for example, some proof of purchase, pin, or authentication in addition to merely reading the code. Alternatively, the proof of purchase may be communicated via the merchant.

The purchaser then includes some personalisation details, for example preferred name, birthday, favourite songs (for a performer), or other details as appropriate. The registered user then has access (by scanning the code) to special content only available to purchasers so connected. For example, a current season jersey for a baseball player may give access to the team media, as well as for that player along with personalised commentary.

In turn, the fans could upload (potentially moderated by a suitable person) their own content—personal messages from fans, questions, video shot from the stands, and so forth. This then creates a potential community of interest for those who have bought the current jersey for that player. This may be added to and from the content created according to the seat based implementation of the present invention.

Use of the seat coding in combination with sporting item or product coding creates a wide variety of possible synergistic opportunities, only available to those who participate in purchase of the appropriate goods and services. For example, this would permit a trifecta game whereby fans wearing a team's jersey that scans a ‘blue’ baseball can win prizes if they scan a drink with a ‘blue’ baseball and their seat scan has a ‘blue’ baseball.

It will be apparent that the operation of the present implementation would allow a large volume of data on patrons' behaviour to be collected. This data, particularly over a period a time, in principle enables teams, brands, venues, vendors and operators to determine very specific arrival and departure times of fans along with other habits, and to target promotions and events with this knowledge.

In the case of a cultural venue, some of the same information can be captured, but it is likely that in many cases the patrons would be discouraged from operating their smartphone or tablets during the performance in a way that is distracting for other patrons. However, messages and comments could be contributed before and after the performance, to also provide a body of reviews and opinions on the work. The text, music or libretto would be provided, together with an audio feed at high quality, particular for spoken performances.

It will be appreciated that many possible implementations of the present invention are possible, with necessary variations for the type of event and venue, and with many different additional or alternative features. For example, the present invention can also be applied to educational facilities. In one implementation in a classroom setting, each student's desk could be coded and act as their hub (with personalised home page) of a connected group. In another educational implementation, a seat at an iconic institution, for example in a famous lecture theatre, may be coded to contain details of previous occupants, events, lectures, etc. People may wish to sit where Max Planck sat for his undergraduate lectures, for example.

In another feature of the invention, multimedia content sent from a seat or clothing item could in effect have an enhanced personalised form of branding whereby push notifications, text, or emails are sent to friends stating, ‘You have a message sent from Bob's Yankee hat.’ (or ‘Sent from David's Box Seat).

It may be possible in some future implementations to use a wireless system of some kind to allow identification of specific seats without seat based coding. GPS, for example, is not accurate enough to reliably identify individual seats. It will be appreciated that for the system to function as intended, specific seats (or possibly groups of seats) must be able to be distinguished from nearby seats with very high accuracy. Alternative location systems could be used, provided they are able to meet this criteria.

It will be appreciated that many additional features could be added to implementations of the present invention, and that the present invention encompasses not only the variations noted, but other variation and the addition of further features on the base of the inventive method and system.

1-16. (canceled)

17. A system for permitting the capture of location specific content at a venue, the system being adapted to receive data including seat location data from patrons at the venue, to identify the location and, upon demand, provide content to patrons, and to receive from patrons and store content selected with respect to at least the seat location data, the seat location data being derived from reading a code or indicia associated with a seat or ticket, the system including a server, data storage, and network communications apparatus so as to operatively enable the system to communicate with portable devices associated with patrons at the venue corresponding to the seat location data.

18. A system according to claim 1, including a large number of seats in a stadium each having a unique readable code, the code being readable by a portable device and the associated location thereby communicated to said server.

19. A system according to claim 2, wherein the seat code is readable by optical, radio frequency, or magnetic sensors, so that a location can be automatically determined and used to provide at least part of a patron identity or authorisation to enable use of said system by one of said patrons.

20. A system according to claim 3, wherein the portable devices are adapted to upload video, audio, text and/or image data associated with the seat location data to said server.

21. A system according to claim 3, wherein the portable devices are adapted to receive video, audio, text and/or image data associated with the seat location data.

22. A system according to claim 5, wherein the data is specifically associated with previous patron usage or entertainment events and is specific to that seat.

23. A system according to claim 2, wherein the system is adapted to store content associated with seat location data over a plurality of events, so as to automatically create a set of historical data contributed at least in part by prior patrons relating to a specific seat in the venue.

24. A method for allowing the capture of location specific content at a venue, the venue including seat location information which is readable by patrons, and wherein at least some of the patrons possess a portable device enabled and operatively adapted to interact with hardware, including a server, network communications hardware and data storage, and adapted to access the seat location information, the method including at least the steps of:
(a) the server receiving location data from one or more portable devices associated with patrons at the venue, the data being generated based upon seat location information derived from reading a code associated with a seat or a ticket by the portable device;
(b) said server then selectively, upon demand, providing content to patrons, receiving content from patrons, and storing content selected with respect to at least the seat location data, the system including a server, data storage, and network communications apparatus so as to operatively enable the system to communicate with portable devices associated with patrons at the venue corresponding to the seat location data.

25. A method according to claim 8, wherein the seat code is readable by optical, radio frequency, or magnetic sensors, so that a location can be automatically determined and used to provide at least part of a patron identity or authorisation to enable use of said system by one of said patrons.

26. A method according to any one of claim 8, wherein the portable devices are adapted to upload video, audio, text and/or image data associated with the seat location data.

27. A method according to claim 8, wherein the portable devices are adapted to receive video, audio, text and/or image data associated with the seat location data.

28. A method according to claim 11, wherein the data is specifically associated with previous patron usage or entertainment events specific to that seat.

29. A method according to claim 10, wherein the system is adapted to store content associated with seat location data over a plurality of events, so as to automatically create a set of historical data contributed at least in part by prior patrons relating to a specific seat in the venue.
